(19) United States
(12) Patent Application Publication
(10) Pub. No.: US 2016/0145004 A1
(43) Pub. Date: May 26, 2016

(54) TELESCOPING SPOUT FOR DISPENSING FLUID

(71) Applicant: JAIME CRUZ REYES, Langley (CA)

(72) Inventor: JAIME CRUZ REYES, Langley (CA)

(21) Appl. No.: 14/550,950

(22) Filed: Nov. 22, 2014

(51) Int. Cl. B65D 25/48; B67D 7/42; B67D 7/04

(52) U.S. Cl. CPC B65D 25/48; B67D 7/04; B67D 7/42

(57) ABSTRACT

Examples of a telescoping spout for dispensing fluid from a container are disclosed. The telescoping spout comprises a base that is configured to be connected to a pouring opening of the container. A telescoping body is connected to the base. The telescoping body comprises a lower section and an upper section shaped to form the telescoping body. The lower section has a cross-section that is greater than a cross-section of the upper section. An outlet is formed at the distal end of the upper section and a tab is connected to a top wall of the upper section to close the outlet of the telescoping body when not in use. The tab is configured to be moved out of a flow path of the fluid to open the outlet. The sidewall of the upper section has a greater thickness than the thickness of a sidewall of the lower section, so that the lower section can fold on itself or can bend to adjust the position of the discharge outlet. When the telescoping body is in a collapsed position the upper section is nested within the lower section and is positioned within the pouring opening of the container. In order to get the telescoping body in extended position the upper section is pulled out of the lower section.

### TECHNICAL FIELD

The present invention relates generally to a pouring spout and more particularly to a telescoping pouring spout that can be secured within an opening of a container and extended outwardly from the opening to facilitate dispensing of fluid from the container.

### BACKGROUND

Unless otherwise indicated herein, the materials described in this section are not prior art to the claims in this application and are not admitted to be prior art by inclusion in this section.

In a motor engine, such as for example internal combustion engines, people need to perform change of motor oil from time to time. Generally, motor oil comes in cans or bottles and then need to be poured into a small opening in the engine's crank case. There is a high likelihood of spillage and difficulty during the pouring process due to the position of the crank case and size of its opening. Generally, people have used conventional funnels to pour motor oil into vehicle engines. While this solves the problem of pouring and to some degree spilling, it requires purchasing a funnel and keeping it separately from the oil container. When used, the oil may stick to the funnel for a considerable period of time and as such may be a source of contamination since any dirt and other debris on the funnel can contaminate the oil or liquid and, in turn, place undue wear and tear on the engine itself. In addition, the funnel needs to be stored in a separate container so that the oil does not drip onto the floor or wherever the funnel rests on. While people often keep one or more oil containers in their cars for an emergency on the road, they do not have the funnels since the funnel can soil the trunk or other areas of the car it is stored.

Other known approaches include providing openings for valves in the cans or a long neck bottles for motor oil. In addition, there are number of built-in (or attachable) pouring sprout that can be contracted (folded) when not in use and extended outwardly when it is desired to dispense fluid out of the container. Most of such solution are complex and cumbersome and increase the cost of the packaging and delivery thus increasing the cost to the consumer.

### SUMMARY

In one aspect, a telescoping spout for dispensing fluid from a container is provided. The spout comprises a telescoping body having a lower section and an upper section connected to each other to form the body. The lower section is connected to a top wall of a base. A distal end of the upper section forms an outlet. The lower section has a cross-section that is greater than a cross-section of the upper section. The base of the telescoping spout is connected to a pouring opening of a container. The upper section has a sidewall that is thicker than a sidewall of the lower section, so that when the telescoping body is in a collapsed position the upper section is nested within the lower section and the telescoping body is positioned within the pouring opening of the container.

In another aspect, a tab is provided at the distal end of the upper section. The tab is connected to the top wall of the upper section to close the outlet of the telescoping body. The tab is configured to move out of a flow path of the fluid to open the outlet or to move in a fluid flow path to close the outlet.

In yet another aspect, the lower and the upper sections are seamlessly connected forming unitary component with a sidewall with variable thickness.

In one aspect, the telescoping spout comprises a weakened tearing zone formed at a periphery of the tab and the top wall of the upper section so that the tab can be pulled up and removed from the upper section.

In addition to the aspects and embodiments described above, further aspects and embodiments will become apparent by reference to the drawings and study of the following detailed description.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure. Sizes and relative positions of elements in the drawings are not necessarily drawn to scale. For example, the shapes of various elements and angles are not drawn to scale, and some of these elements are arbitrarily enlarged and positioned to improve drawing legibility.

FIG. 1 is a perspective view of an example of a pouring spout in an extended position;

FIG. 2 is a perspective view of an example of a pouring spout in a contracted position within an opening of a container.

### DETAILED DESCRIPTION OF SPECIFIC EMBODIMENTS

There are many instances when the specific design of container and neck portions makes it difficult to efficiently dispense fluid from the container. For example, when one need to fill the crank case or windshield washer reservoir it is necessary to invert the container storing the oil or windshield washing fluid in order to facilitate fluid flow out of the container and into the reservoir. However, the flow may occur before the opening of the container is positioned over the opening of the reservoir (receptacle) causing fluid spillage and contamination of the engine.

Present invention describes a pouring spout that alleviates the spilling problems that occur during dispensing fluid from bottle or container. The device includes a means to efficiently pour liquid when transferring liquid from a bottle to another container and reduces the overall amount of time and cost associated with changing oil. It provides a convenient and safe way to pour oil from motor oil bottles, or other liquids from containers, eliminates the need for oil funnels which cause contamination from dirt and debris, and also minimizes the chance for messy and difficult-to-clean spills. The pouring spout of the present invention can be incorporated with a bottle or a container holding the liquid.

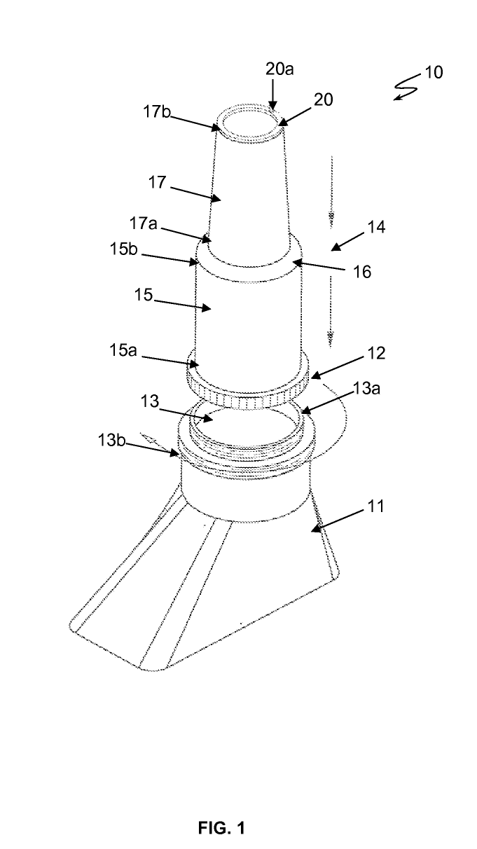

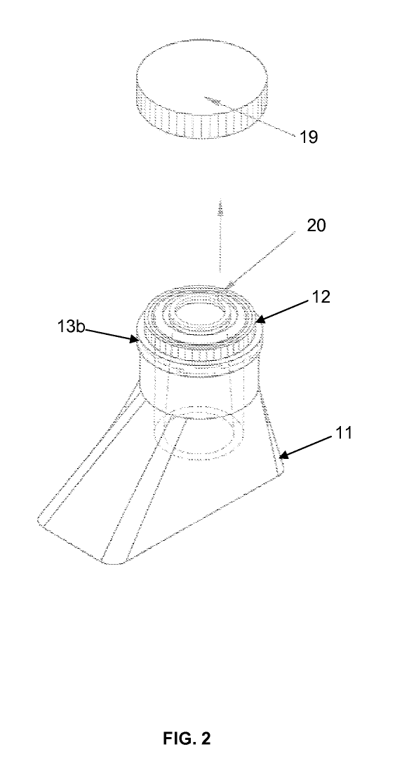

FIG. 1 shows an example of a pouring spout 10 comprising a base 12 and a telescoping body 14. The base 12 can be made of a rigid plastic or any other suitable material. It can be sized and shaped to fit within an opening of a container, such as an opening 13 of the container 11 only partially shown in FIGS. 1 and 2. In one implementation, the base can be annular, ring, shaped with a flat bottom surface. An inner surface of the base 12 can be threaded so it can be screwed onto a matching thread of the opening 13. For example, the opening 13 can have two threaded surfaces such as thread 13a and thread 13b. The thread 13b can have slightly bigger diameter than the thread 13a and can be sized so that a container's cap or lid 19 (FIG. 2) can be screwed in a fluid sealing fashion thereon. The thread 13a can have a smaller diameter than the thread 13b and can project slightly upwardly from a top surface of the thread 13b. The base 12 of the pouring spout 10 can be tightly screwed on the thread 13a. In another implementation, the base 12 can be positioned within the opening 13 of the container 11. In one implementation the base 12 can be positioned over the opening 13 of the container 11 and the cap 19 can be screwed on a thread formed on the outside wall of the base 12. When the spout 10 is in its collapsed position (see FIG. 2) within the opening 13 the cap 19 can be put thereon sealing the opening 13. In yet another implementation, the pouring spout 10 can be permanently connected to the opening 13 of the container 11. Person skilled in the art would understand that the exact position of the base 12 in the opening 13 is not critical and the opening 13 can be sealed by the cap 19 when the cap 19 contacts either a top wall of the container 11 (top surface of the opening 13) or a top wall of the base 12.

The telescoping body 14 comprises at least two sections such as a lower section 15 and an upper section 17. The lower section 15 can be configured to receive the upper section 17 when the telescoping body 14 is in a collapsed position as depicted in FIG. 2. The lower section 15 comprises a first end 15a which is integrally joined to the top wall of the base 12. The upper section 17 is configured to fit into a receptacle's opening (not shown), e.g. an engine's oil opening or any other opening of any receptacle. A sidewall of the lower section 15 can be made of a malleable and soft rubber or plastic or any other material so it can flex, bend and fold back upon itself. The upper section 17 is made of a flexible yet firm rubber or a suitable plastic material or any other suitable material so that it is flexible and can be secured within the opening of the receptacle, but its sidewall has enough firmness that the upper section does not fold on itself. In one implementation, both the lower section 15 and the upper section 17 can be made of the same material but with different thickness of the sidewall. For example, the thickness of the sidewall of the lower section 15 is less than the thickness of the sidewall of the upper section, thus affecting the firmness of the upper section 17. The telescoping body 14 can have a conical shape so that the lower section 15 has a greater cross-section than the cross-section of the upper section 17. The lower section 15 and the upper section 17 can be integrally and seamlessly connected to each other making one unitary element with a sidewall with variable thickness. For example the telescoping body 12 can be molded or extruded so that its lower section 15 has thinner sidewall (which is bendable and can fold on itself) while its upper section has a sidewall which is thicker and thus firmer. In another implementation the lower section 15 and the upper section 17 can be connected to each other forming a seam, such as a seam or a shoulder 16. The upper section 17 and the lower section 15 can be connected to each other by gluing or welding or by using some mechanical clamping device to join the sections 15 and 17 one to another and form the telescoping body 14. In one implementation, the lower section 15 and the upper section 17 can be made of different material. For example the lower section 15 can be made of a soft rubber while the upper section 17 can be made of a flexible but firm plastic. The upper section 17 comprises a first end 17a integrally connected to a second end 15b of the lower section 15. At the distal end of the upper section 17 of the telescoping body 14 is a fluid outlet 17b. The upper section 17 is sized so that its cross-section is smaller than the cross-section of the lower section 15 so that when pushed in a direction toward the lower section 15 (in direction of the arrows of FIG. 1) it can be inserted within the lower section 15. The lower section 15 can have a cylindrical or conical shape. In case the lower section 15 has a conical shape, its cross-section will gradually decrease from the first end 15a to the second end 15b so that the second end 15b has a smaller diameter than the first end 15a. The upper section 17 can have cylindrical or conical shape. FIG. 1 depicts a pouring spout 10 with lower section 15 having a cylindrical shape while the upper section 17 having a conical shape. Person skilled in the art would understand that the lower and the upper sections 15, and 17 can have different shapes without departing from the scope of the invention as long as the upper section 17 has a smaller cross-section than the lower section 15 and can be nested within the lower section 15 when the telescoping body 14 is in a collapsed position. The outlet 17b can have a flat top surface or its top surface can be angled to facilitate easier pouring activity. Covering the outlet 17b of the pouring spout 10 is a pull-tab 20. The pull-tab 20 can be used as a lid/flap to close/open the outlet 17b and prevent contamination of the fluid before use and as a handle to pull out the pouring spout 10 in extended position (shown in FIG. 1) or to push it in collapsed position as shown in FIG. 2, when the telescoping body 14 is positioned within the opening 13 of the fluid container 11. The tab 20 can be made of rigid plastic or metal (i.e. aluminum). The tab 20 can be connected to the sidewall of the upper section 17 with a hinge or any other movable joint. The tab 20 is configured to close the outlet 17b thus preventing any accidental spillage of fluid or contamination of the fluid with debris. The tab 20 can further comprise gripping means 20a configured to easier grab the tab 20 and pull it up or move it sidewise to open the outlet 17b. So, the tab 20 closes the outlet 17b when the container is stored and it can be moved out of the flow path for dispensing the fluid. In one implementation, the tab 20 can be connected to the top wall of the upper section 17. It may further comprise a weakened tearing zone (not shown) around periphery of the tab 20, thus when the tab 20 is pulled up it can be disconnected (removed) from the outlet 17b and can be discarded.

FIG. 2 shows the pouring spout 10 in collapsed position. The upper section 17 is pushed within the lower section 15. The lower section enveloping the upper section is folded within the opening 13 of the container 11. When the cap 19 is removed one can grab the top of the upper section 17 and pull it out of the lower section 15 and at the same time can pull the lower section 15 out of the opening 13.

In operation, the pouring spout 10 is connected to the opening 13 by, for example, screwing the base 12 on the thread 13a. When not in use the pouring spout 10 is in its collapsed position as shown in FIG. 2. The upper section 17 is pushed within the lower section 15 and the spout 10 is positioned within the opening 13. The tab 20 closes the outlet 17b and the cap 19 closes the container's opening 13. When one want to dispense the fluid into some receptacle, e.g. to add motor oil into the crank case, the cap 19 is removed and then the telescoping body 14 is extended to form a fluid flowing passage. The telescoping body 14 can be extended by grabbing the tip of the upper section 17 or by pulling the tab 20. When the body 14 is pulled out of the opening 13, the tab 20 is moved out of the flow path of the fluid to open the outlet 17b. Then the upper section 17 and in particularly the outlet 17b is positioned within the opening of the receptacle and the container is inverted to facilitate fluid flow. The outlet 17b of the pouring spout 10 can be configured to fit into the engine's oil opening or the opening of any other receptacle. User can pull the telescoping body 14 so that it is in its fully extended position or can be extended partially to the length needed.

While particular elements, embodiments and applications of the present disclosure have been shown and described, it will be understood, that the scope of the disclosure is not limited thereto, since modifications can be made without departing from the scope of the present disclosure, particularly in light of the foregoing teachings. Thus, for example, in any method or process disclosed herein, the acts or operations making up the method/process may be performed in any suitable sequence and are not necessarily limited to any particular disclosed sequence. Elements and components can be configured or arranged differently, combined, and/or eliminated in various embodiments. The various features and processes described above may be used independently of one another, or may be combined in various ways. All possible combinations and sub-combinations are intended to fall within the scope of this disclosure. Reference throughout this disclosure to “some embodiments,” “an embodiment,” or the like, means that a particular feature, structure, step, process, or characteristic described in connection with the embodiment is included in at least one embodiment. Thus, appearances of the phrases “in some embodiments,” “in an embodiment,” or the like, throughout this disclosure are not necessarily all referring to the same embodiment and may refer to one or more of the same or different embodiments. Indeed, the novel methods and systems described herein may be embodied in a variety of other forms; furthermore, various omissions, additions, substitutions, equivalents, rearrangements, and changes in the form of the embodiments described herein may be made without departing from the spirit of the inventions described herein.

Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

The example calculations, simulations, results, graphs, values, and parameters of the embodiments described herein are intended to illustrate and not to limit the disclosed embodiments. Other embodiments can be configured and/or operated differently than the illustrative examples described herein. Indeed, the novel methods and apparatus described herein may be embodied in a variety of other forms; furthermore, various omissions, substitutions and changes in the form of the methods and systems described herein may be made without departing from the spirit of the inventions disclosed herein.

1. A telescoping spout for dispensing fluid from a container comprising:
a base having a bottom wall, a top wall and a side wall extending from a periphery of the bottom wall, the base being configured to connect to a pouring opening of a container;
a telescoping body having a lower section and an upper section connected to each other to form the telescoping body, the lower section connected to the top wall of the base, a distal end of the upper section forming an outlet, the lower section having a cross-section that is greater than a cross-section of the upper section; and
a tab connected to a top wall of the upper section closing the outlet of the telescoping body, the tab being configured to be moved out of a flow path of the fluid to open the outlet,
thickness of a sidewall of the upper section being greater than thickness of a sidewall of the lower section, the sidewall of the lower section configured so that the lower section is bendable and foldable, the sidewall of the upper section is firm,
wherein when that telescoping body is in an extended position the lower section is bendable so that the upper section is angled with respect to the lower section, and when the telescoping body is in a collapsed position the lower section fold back upon itself and the upper section is nested within the lower section.

2. The telescoping spout of claim 1, wherein the lower and the upper sections are seamlessly connected forming unitary component with a sidewall with variable thickness.

3. The telescoping spout of claim 2, wherein the lower and the upper sections are made of same material.

4. The telescoping spout of claim 1, wherein the lower and the upper sections are made of different material.

5. The telescoping spout of claim 1, further comprising a movable joint to connect the tab to the top wall of the upper section.

6. The telescoping spout of claim 1, further comprising a weakened tearing zone formed at a periphery of the tab and the top wall of the upper section.

7. The telescoping spout of claim 1, further comprising a grabbing means projecting upward from a top surface of the tab.

8. The telescoping spout of claim 1, wherein the base further comprises a connecting means to connect to the pouring opening of the container.

9. The telescoping spout of claim 8, wherein the connecting means comprises a thread formed at an inner surface of a base sidewall.

10. The telescoping spout of claim 8, wherein the connecting means of the base comprises a thread formed at an outer surface of a base sidewall.
